(19) United States
(12) Patent Application Publication
(10) Pub. No.: US 2026/0089399 A1
(43) Pub. Date: Mar. 26, 2026

(54) SEGMENTED LED ASSISTED AUTOMATIC EXPOSURE CONTROL

(71) Applicant: Lumileds LLC, San Jose, CA (US)

(72) Inventor: Erkan Diken, Eindhoven (NL)

(21) Appl. No.: 19/138,032

(22) PCT Filed: Dec. 12, 2023
(86) PCT No.: PCT/US2023/083649

§ 371 Date: Jun. 11, 2025

Related U.S. Application Data
(60) Provisional application No. 63/432,942, filed on Dec. 15, 2022.

(51) Int. Cl. H04N 23/74; H04N 23/56; H04N 23/71; H04N 23/72; H04N 23/73; H04N 23/76; H04N 23/81

(52) U.S. Cl. CPC H04N 23/74; H04N 23/56; H04N 23/71; H04N 23/72; H04N 23/73; H04N 23/76; H04N 23/81

(57) ABSTRACT

An adaptive light source is provided to adjust illumination parameters based on analysis of the image quality. Region-based exposure metering of an image of an LED-illuminated scene is determined, as are the exposure modes of the adaptive light source used to illuminate the scene. The image quality is analyzed to determine whether the image is acceptable based on noise level, motion artifacts, and framerate. If not acceptable, portions of the scene having the highest contributions to noise are determined and driving parameters of LEDs mapped to the portions based on regions of the region-based exposure metering are adjusted to improve the image quality. The distances of objects in the scene are also determined and the image analyzed based on the distances to distinguish dark and low reflectance objects with far away objects in the scene.

### PRIORITY CLAIM

This application claims the benefit of priority to U.S. Provisional Patent Application Ser. No. 63/432,942, filed Dec. 15, 2022, which is incorporated herein by reference in its entirety.

### FIELD OF THE DISCLOSURE

The present disclosure relates to an illumination apparatus that contains a segmented light-emitting diode (LED) array. In particular, embodiments are directed to control of the segmented LED array for illumination of a scene by the illumination apparatus.

### BACKGROUND OF THE DISCLOSURE

There is ongoing effort to improve illumination systems. In particular, it is desirable to improve image quality of images taken using the segmented LED array.

### BRIEF DESCRIPTION OF THE DRAWINGS

FIG. 1 shows an illumination apparatus, in accordance with some examples.

FIG. 2 illustrates a closed-loop automatic exposure control (AEC) method, in accordance with some examples.

FIG. 3 illustrates a simplified AEC flowchart, in accordance with some examples.

FIG. 4 illustrates a segmented LED AEC flowchart, in accordance with some examples.

FIG. 5A illustrates lighting in a segmented LED, in accordance with some examples.

FIG. 5B illustrates region-based exposure metering associated with FIG. 5A, in accordance with some examples.

FIG. 6 illustrates a block diagram of a mobile device in accordance with some embodiments.

### DETAILED DESCRIPTION

Adaptive lighting control may be used to combat exposure issues that may exist in conventional LED flash modules due to inhomogeneities in lighting conditions in a scene, as well as differing distances between objects in the scene and the illumination apparatus. In particular, adaptive lighting control in an illumination apparatus that contains a segmented LED array (an LED array that contains multiple segments) and sensor may provide additional complications.

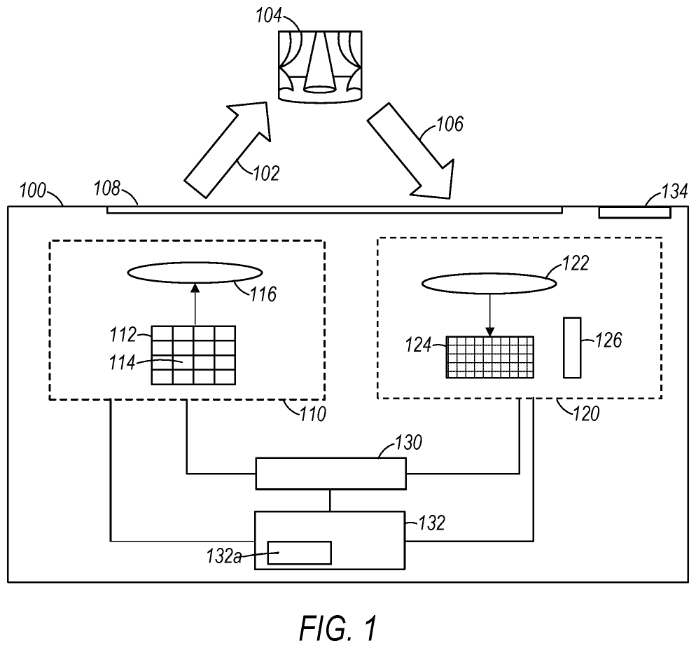

FIG. 1 shows an illumination apparatus 100, in accordance with some examples. The illumination apparatus 100 may be, for example, a smart phone or standalone camera that contains an adaptive LED light source. The illumination apparatus 100 may include both a light source 110 and a camera 120. The camera 120 may capture an image of a scene 104 during an exposure duration of the camera 120, whether or not the scene 104 is illuminated by the light source 110. A processor 130 may be used to control various functions of the light source 110 and the camera 120, including whether or not a shutter is open in an opening 108 of a housing of the illumination apparatus 100.

The opening 108 may be a single opening as shown in FIG. 1 or may include multiple separate openings. Similarly, the shutter may be a single shutter that covers both the light source 110 and the camera 120 or may include multiple separate shutters that covers only one of the light source 110 or the camera 120 and are individually controllable by the processor 130.

The illumination apparatus 100 may include one or more LED arrays 112. Each of the one or more LED arrays 112 may include a plurality of LEDs 114 that may produce light during at least a portion of the exposure duration of the camera 120. Each of the one or more LED arrays 112 may contain segmented LEDs 114, as described in more detail below.

Each of the LEDs 114 may be formed from one or more inorganic materials (e.g., binary compounds such as gallium arsenide (GaAs), ternary compounds such as aluminum gallium arsenide (AlGaAs), quaternary compounds such as indium gallium phosphide (InGaAsP), or other suitable materials), which are more robust than organic LEDs, allowing use in a wider variety of environments. Each of the LEDs 114 may emit light in the visible spectrum (about 400 nm to about 800 nm) or may also emit light in the infrared spectrum (above about 800 nm). In some embodiments, one or more other layers, such as a phosphor layer may be disposed on each of the one or more LED arrays 112. LEDs 114 in a particular LED array 112 that emit light in the infrared spectrum may be, for example, interspersed with LEDs 114 may emit light in the visible spectrum, or each type of LED (visible emitter/infrared emitter) may be disposed on different sections of the particular LED array 112. Alternatively, each LED array 112 may only emit light in either the visible spectrum or the infrared spectrum; separate (one or more) LED arrays may be used to emit light in the infrared spectrum, each of the individual LED array 112, LEDs 114 and/or segments may be controllable by the processor 130.

Each of the one or more LED arrays 112 may be conventional LED arrays or a micro-LED array, the latter of which includes thousands to millions of microscopic LEDs 114 that may emit light and that may be individually controlled or controlled in groups of pixels (e.g., 5×5 groups of pixels). The microLEDs are small (e.g., <0.01 mm on a side) and may provide monochromatic or multi-chromatic light, typically red, green, or yellow using inorganic semiconductor material such as that indicated above.

The light source 110 may include at least one lens 116 and/or other optical elements such as reflectors. The lens 116 and/or other optical elements may direct the light emitted by the one or more LED arrays 112 toward the scene 104 as illumination 102.

The camera 120 may sense light at least the wavelength or wavelengths emitted by the one or more LED arrays 112. Similar to the light source 110, the camera 120 may include optics (e.g., at least one camera lens 122) that are able to collect reflected light 106 of the illumination 102 that is reflected from and/or emitted by the scene 104. The camera lens 122 may direct the reflected light 106 onto a multi-pixel sensor 124 (also referred to as a light sensor) to form an image of the scene 104 on the multi-pixel sensor 124.

The processor 130 may receive a data signal that represents the image of the scene 104. The processor 130 may additionally control and drive the LEDs 114 in the one or more LED arrays 112 via one or more drivers 132. For example, the processor 130 may optionally control one or more LEDs 114 in the one or more LED arrays 112 independent of another one or more LEDs 114 in the one or more LED arrays 112, so as to illuminate the scene in a specified manner.

In addition, one or more detectors 126 may be incorporated in the camera 120. In other embodiments, instead of being incorporated in the camera 120, the one or more detectors 126 may be incorporated in one or more different areas, such as the light source 110 or elsewhere close to the camera 120. The one or more detectors 126 may include multiple different sensors to sense visible and/or infrared light, and may further sense the ambient light and/or variations/flicker in the ambient light in addition to reception of the reflected light from the LEDs 114. The multi-pixel sensor 124 of the camera 120 may be of higher resolution than the sensors of the one or more detectors 126 to obtain an image of the scene with a desired resolution. The sensors of the one or more detectors 126 may have one or more segments (that are able to sense the same wavelength/range of wavelengths or different wavelength/range of wavelengths), similar to the LED arrays 112. In some embodiments, if multiple detectors are used, one or more of the detectors may detect visible wavelengths and one or more of the detectors may detect infrared wavelengths; the detectors may be individually controllable by the processor 130.

In some embodiments, instead of or in addition to being provided in the camera 120, one or more of the sensors of the one or more detectors 126 may be provided in the light source 110. In some embodiments, the light source 110 and the camera 120 may be integrated in a single module, while in other embodiments, the light source 110 and the camera 120 may be separate modules that are disposed on a PCB. In other embodiments, the light source 110 and the camera 120 may be attached to different PCBs—for example, as the camera 120 may be thicker than the light source 110, which may result in design issues if the light source 110 and the camera 120 are attached to the same PCB. In the latter embodiment, multiple openings may be present in the housing at least one of which may be eliminated with the use of an integrated light source 110 and camera 120.

The LEDs 114 may be driven using a direct current (DC) driver or pulse width modulation (PWM). Using DC driving may encounter color differences if the segmented one or more LED arrays 112 is driven at different current densities, while PWM driving may generate artifacts due to ambient lighting conditions. The flicker sensor may sense the variation of artificial lighting at the wall current frequency or electronic ballasts frequencies (e.g., 50 Hz or 60 Hz or an integral multiple thereof), in addition to the phase of the flicker. The camera sensor is then tuned to an integration time of an integral multiple of the time period (1/f) or triggered at the phase where the illumination changes most slowly (minimum or maximum intensity, with the maximum intensity preferred for signal-to-noise ratio considerations). The LEDs 114 may be driven using a PWM whose phase shift varies between LEDs 114 to reduce potential current surge issues. As shown, one or more drivers 132 may be used to drive the LEDs 114 in the one or more LED arrays 112, as well as other components, such as the actuators.

The illumination apparatus 100 may also include an input device 134, for example, a user-activated input device such as a button that is depressed to take a picture. The light source 110 and camera 120 may be disposed in a single housing.

As above, the light source 110 of FIG. 1 may be an adaptive flash that contains individually addressable LED segments to allow selective illumination of the scene 104. For array sizes larger than 3×3 matrices, the LED segments may be combined with an integrated driver to allow the function of individual addressability and obtain the small form factor desired for mobile devices without creating issues in layout of the semiconductor layers used to create the integrated devices. In addition, the integration of the driver and LED in a single device increases the thermal challenges of the overall structure due to the increased thermal load on the combined structure. Moreover, as above, the number of openings in the housing of the mobile device may be reduced in embodiments in which a sensor for ambient light and/or flicker detection is integrated in the light source/camera. Limitations on the number of openings in the housing may increase structural integrity of the housing, as well as improving the industrial design of the mobile device.

In particular, the processor 130 may include an exposure control unit 132a. The exposure control unit 132a may measure the ambient conditions of the scene 104 and, based on measurement algorithms, the exposure control unit 132a may compute tuning parameters of the light source 110. The computed parameters may be provided as feedback to different part of the illumination apparatus 100. This mechanism may be automated in a closed-loop system. The computed parameters may include, for example, shutter speed (used for a cover of the aperture/opening 108 to measure the ambient conditions and/or for illumination based thereon), and analog and digital gains based on the aperture/opening 108 of the lens 116 being fixed. The aperture of the shutter may be fixed in size or variable in size as well, and, if variable, may be added as a parameter as explained herein.

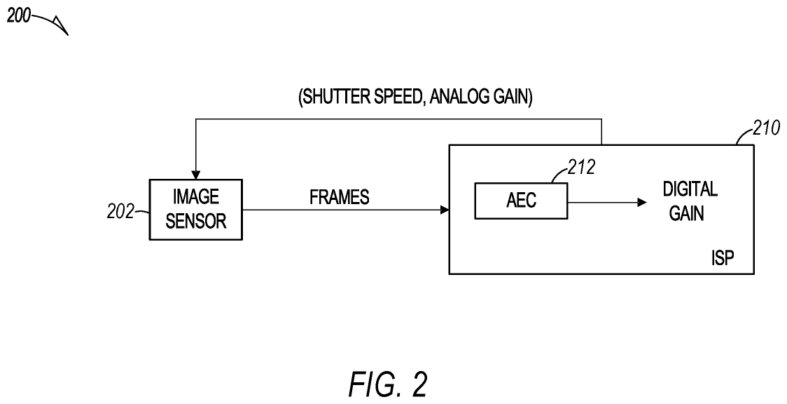

This system is shown in FIG. 2. Specifically, FIG. 2 illustrates a closed-loop AEC method 200, in accordance with some examples. The AEC method 200 shown in FIG. 2 shows only limited operations; other operations and parameters may be present, but are not shown for convenience. The image sensor 202 (the multi-pixel sensor 124 shown in FIG. 1) may send multiple frames to the processor 210 (which may be an image signal processor (ISP) as shown in FIG. 2). Each frame may contain an image of the scene 104 shown in FIG. 1.

The processor 210 may contain an AEC 212, which may provide a gain, such as a digital gain as an output. The AEC 212 may measure the ambient conditions and, based on one or more measurement algorithms, may compute tuning parameters. The computed tuning parameters may be provided as feedback to other parts of the illumination apparatus 100 shown in FIG. 1.

The computed parameters may include shutter speed, analog gain, and digital gain. The shutter speed and analog gain may, for example, be used to tune the image sensor 202. Analog gain may be provided by elements such as a power amplifier from the image sensor 202 to the processor 210. Digital gain may be used as another tuning parameter in the image signal processor used in software processing of the image.

As the LED arrays 112 shown in FIG. 1 may be segmented, the computed parameters may specifically enable a segmented LED assisted exposure control mechanism. In particular, an image quality analysis operation may be provided in the exposure control flow. The image quality analysis step may judge the image regarding noise level (e.g., signal-to-noise ratio of each pixel or segment), motion artifact presence, frame rate, and other parameters. As a result of the analysis, appropriate segments of the LED may be activated to illuminate a region of the scene 104. The LED setting calculation may also take the distances of the objects in the scene 104 into account as the impact of the illumination 102 may be limited for the objects that are relatively far (e.g., >about 3 m) from the illumination apparatus 100. Distance information may also help to distinguish darker (formed from a dark material or colored dark—e.g., black or another darker color) or lower reflectance objects in the scene 104 that are relatively close to the illumination apparatus 100 from lighter or higher reflectance objects in the scene 104 that are farther away from the illumination apparatus 100. The distance of the objects may be determined using one or more previous images captured using visible and/or IR light from the illumination apparatus 100 using one or more methods that include, e.g., illumination intensity, time-of-flight, relative positional differences between sequential images, relative object sizes within each image among others (and perhaps using an AI algorithm that is trained using images with objects at various distances).

The use of an adaptive LED light source may improve over-and under-exposure that may occur with the use of a conventional LED flash. The adaptive LED light source, as above, may include multiple segments. Each segment of an adaptive LED can be controlled individually and may have its own settings (e.g., current, PWM) to illuminate the scene. If used as a camera flash, the illumination pattern emitted by the light source (the LED arrays 112) can be adapted to the scene 104. For instance, the light source may provide more light to parts of the scene 104 that are not well lit by ambient light, and less light to parts of the scene 104 that are well lit by ambient light or are very close to the illumination apparatus 100.

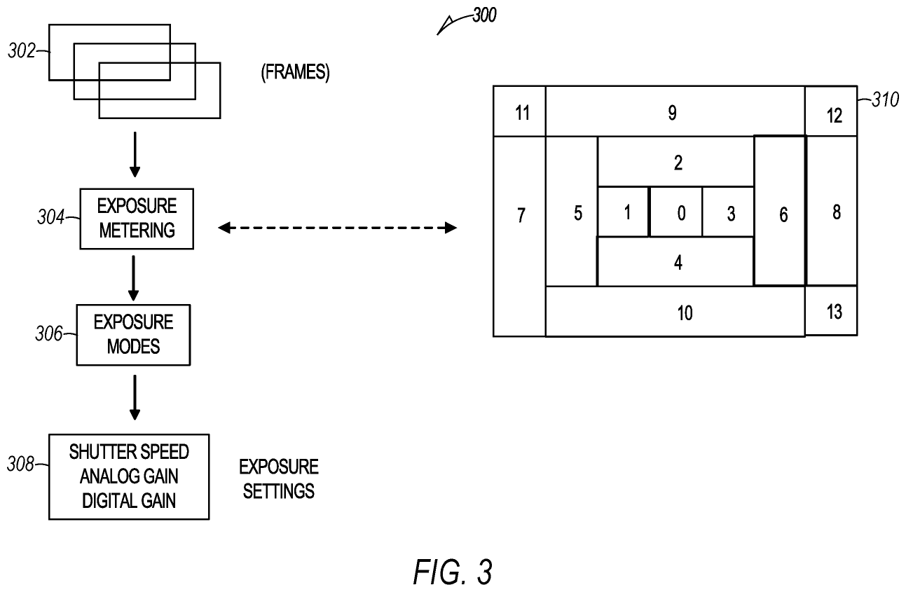

FIG. 3 illustrates a simplified AEC flowchart 300, in accordance with some examples. Similar to the above, other operations may be present in the AEC flowchart 300 in FIG. 3, but are not shown for convenience.

At operation 302, images of the scene are captured by the image sensor and sent to the processor in frames. The frames may be transmitted individually or in sets of frames that have been batched. The sets of frames may be sent at predetermined periods, after a predetermined number of frames have been accumulated, or upon activation by a user.

Whether the frames are transmitted individually or in sets, the exposure may be metered for every incoming frame from image sensor using an exposure metering unit in the processor at operation 304. The exposure metering unit may be able to implement different types of algorithms. One such algorithm may include a region-based exposure metering algorithm, in which the scene 310 may be divided into different segments that each has a given weight. The weights may be independent of each other. The scene 310 may be divided into equal size segments or, as shown in FIG. 3, may be divided into segments of different sizes. The number of segments of each size may be the same or may be different. As shown in FIG. 3, a first set of segments (0, 1, 3, 11, 12, 13) have a first size, a second set of segments (5, 6, 8) have a second size that is larger than the first size, a third segment (7) has a third size that is larger than the second size, and a fourth set of segments (9, 10) have a fourth size that is larger than the third size. A target exposure value may be computed for each frame based on the weighted segment values.

In other embodiments, the manner of division of the scene 310 into regions may vary and be different than as shown in FIG. 3. To compute the light level of the scene 310, the exposure metering algorithm may measure the light intensity of the scene 310 in different ways. One way of such measurement is to divide the scene 310 into regions and measure the light intensity of each region separately. In this way, the camera (processor) may be able to determine the light levels in the scene 310.

In one example, a scene with strong light source (e.g., sun), clouds, sky on the background and an object in the foreground. Taking average of each pixel to compute the light level of such a scene may not result in an optimum exposure setting. To cope with the differentials, different exposure metering methods are introduced. Either the algorithm or the user can decide on which region of the scene to focus and use for exposure metering. The algorithm may be informed about the most desirable part of the scene—either by manual intervention of the user or by an algorithm (e.g., facial recognition). This may allow the desirable region(s) of the scene have a proper weight. In addition to the exposure metering, the software can use other algorithms (e.g., intensity histogram of an image) to add more constraints for computing light level of the scene.

The exposure mode may be determined at operation 306. During the exposure mode, the measured light level of the scene may be mapped/translated into analog/digital gains and the shutter speed parameter space. These parameters are used during picture-taking and image processing to achieve a target image of the measured scene. The target exposure value may then be adjusted based on the exposure mode. A relationship between the exposure mode and values of the parameters to be adjusted may be stored in a memory within the illumination apparatus. At operation 308, the adjusted target exposure value may be translated into parameters of the illumination apparatus, which include shutter speed, analog gain, and digital gain. The exposure settings may be tuned to get a desired exposure of the scene. These parameters may be carefully tuned to overcome other side effects related to the various parameters. For example, as the shutter speed controls a time window over which the sensor is exposed to light, in low light or partially low light environments, the shutter tends to be open longer to capture more light. However, the shutter being open for longer periods may result in unwanted results, including motion artifacts (which may occur if there are moving objects in the scene), as well as the use of a longer shutter time may prevent higher frame rates. The latter case may have ramifications for applications in which higher frame rates are to be used.

The analog gain is used to amplify the signal values on the sensor before analog-to-digital conversion. In low-light or partially low-light environments (i.e., a portion of the scene is not well lighted), the analog gain may be set to higher values than in high-light environments. Digital gain may be applied in the ISP when the analog gain is insufficient to provide the desired amount of gain. However, higher digital gains may result in increased noise in the resulting image. Accordingly, an internal algorithm run by the processor may determine an appropriate combination of analog and digital gain to achieve a particular result.

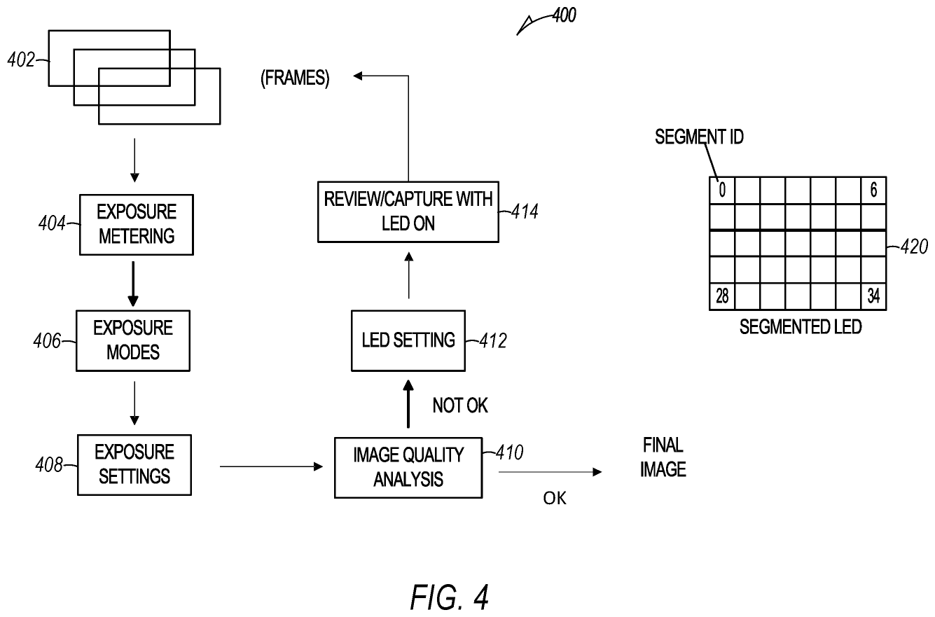

To this end, FIG. 4 illustrates a segmented LED AEC flowchart, in accordance with some examples. The segmented LED AEC flowchart 400 is similar to the AEC flowchart 300 in FIG. 3. As above, other operations may be present in the AEC flowchart 400 in FIG. 4, but are not shown for convenience.

A first set of operations of FIG. 4 are similar to those of FIG. 3; at operation 402, images of the scene are captured by the image sensor and sent to the processor in frames, where the exposure of every incoming frame from image sensor may be metered at operation 404, the exposure mode may be determined at operation 406, and at operation 408, the adjusted target exposure value may be translated into exposure setting parameters that may include shutter speed, analog gain, and digital gain.

After determining the exposure setting parameters, the image quality may be analyzed by the processor at operation 410. The image quality analysis may determine whether or not image quality metrics are met and whether or not the image quality is acceptable. The quality metrics can be perceptual/subjective or objective, depending on which metric is chosen to be optimized (see, e.g., https://towardsdatascience.com/deep-image-quality-assessment-30ad71641fac, herein incorporated by reference in its entirety). As above, the image quality can be affected by both the noise level (which may be higher than expected due to the higher applied gains) and the presence of motion artifacts and reduced framerate due to an extended shutter time, among others. Acceptable quality metric values may be stored in the illumination apparatus for comparison by the processor.

If one or more of the image quality metrics are not satisfied, the image quality analysis at operation 410 may determine that the image quality is not sufficient. The processor, in response, may determine new LED settings at operation 412. That is, the processor may calculate which part of the scene has the most contribution to the noise (e.g., because of higher gains or longer shutter time). In other embodiments, the processor may calculate more than one part of the scene that have highest contributions to the noise.

As a result of the analysis, appropriate segments of each LED array may be set to illuminate a region of the scene using updated settings and other images captured using the segmented LED 420 and image sensor using the updated settings at operation 414. The settings (e.g., driving current supplied to the LEDs) may be adjusted (e.g., increased) by a predetermined fixed amount to improve the noise. This may continue repeatedly until the parameters result in a sufficiently low noise of the portions of the image such that the image quality analysis results in a final image that is satisfactory (meets the predetermined image quality metrics).

The LED setting calculation can also take into account the distances of the objects in the scene, which may be a separate calculation based on earlier visible or infrared illumination. As above, the distance may be considered because the impact of the illumination may be limited for objects that are farther away (e.g., >3m) from the illumination apparatus. As above, distance information may also help to distinguish darker or lower reflectance objects in the scene that are relatively close to the illumination apparatus from lighter or higher reflectance objects in the scene that are farther away from the illumination apparatus.

The loop of the segmented LED AEC flowchart 400 shown in FIG. 4 may thus operate continuously until the processor determines that a satisfactory final image has been obtained (using the adjusted parameters for one or more of the LED segments).

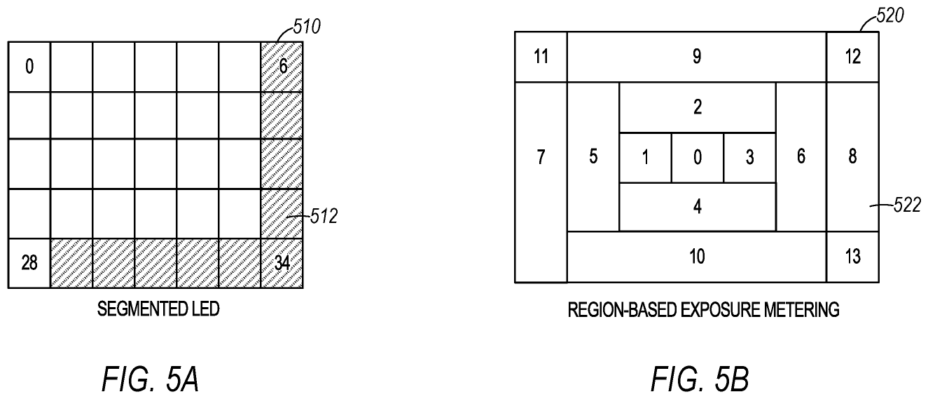

FIG. 5A illustrates lighting in a segmented LED, in accordance with some examples. As shown in FIG. 5A, the segments 512 of the segmented LED 510 are uniform sizes. In particular, the LEDs in segment IDs 6, 13, 20, 27, and 29-34 illuminate a portion of a scene with poor ambient lighting conditions.

FIG. 5B illustrates region-based exposure metering associated with FIG. 5A, in accordance with some examples. The regions 522 of the metered image 520 in FIG. 5B may have different sizes, which, as above, may be chosen by manual selection or dependent on algorithmic decisions. As shown, problematic segment IDs 12, 8, 13, and 10 have poor ambient light (corresponding to the segments 512 in FIG. 5A) and the LED settings may be adjusted accordingly. In particular, in response to determining that the ambient lighting is poor in these regions, the processor may adjust the exposure settings in the problematic regions to higher values; the corresponding segments 512 of the segmented LED 510 may be set to be active during exposure measurement (in preview mode) and eventually the final picture may be taken with the appropriate flash current for each segment 512. As a result, noise and other artifacts due to higher gains and shutter time may be reduced or eliminated. Each segment may have one or more LEDs. As shown, at least one of the regions 522 and the segments 512 may have identical areas and at least one of the regions 522 and the segments 512 may have different areas. As the segments 512 are being independently controlled, the area of the at least one of the regions 522 may be larger than (i.e., a multiple of) that of the segments 512; that is, the area of multiple segments 512 may correspond to a single one of the regions 522. The combination of all of the regions 522 forms the image and covers the identical area as combination of all of the segments 512.

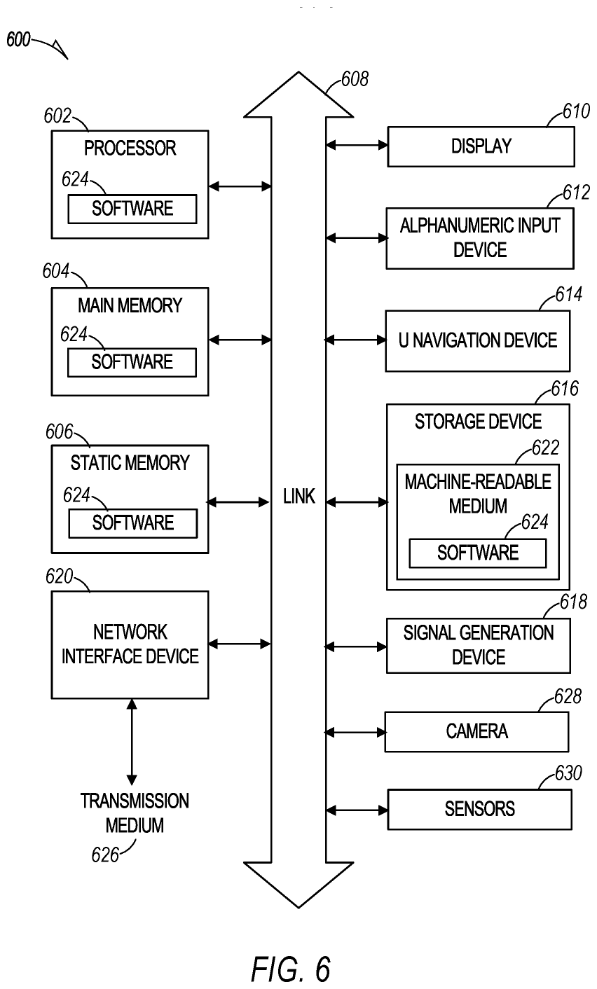

FIG. 6 illustrates a block diagram of a mobile device in accordance with some embodiments. The mobile device 600 may be a UE such as a specialized computer, a personal or laptop computer (PC), a tablet PC, or a smart phone. Various elements may be provided on the PCB indicated above. Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The mobile device 600 may include a hardware processor (or equivalently processing circuitry) 602 (e.g., a central processing unit (CPU), a GPU, a hardware processor core, or any combination thereof), a main memory 604 and a static memory 606, some or all of which may communicate with each other via an interlink (e.g., bus) 608. The main memory 604 may contain any or all of removable storage and non-removable storage, volatile memory or non-volatile memory. The mobile device 600 may further include a display 610 such as a video display, an alphanumeric input device 612 (e.g., a keyboard), and a user interface (UI) navigation device 614 (e.g., a mouse). In an example, the display 610, input device 612 and UI navigation device 614 may be a touch screen display. The mobile device 600 may additionally include a storage device (e.g., drive unit) 616, a signal generation device 618 (e.g., a speaker), a network interface device 620, one or more cameras 628, and one or more sensors 630, such as a global positioning system (GPS) sensor, compass, accelerometer, or other sensor such as those described herein. The mobile device 600 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a non-transitory machine readable medium 622 (hereinafter simply referred to as machine readable medium) on which is stored one or more sets of data structures or instructions 624 (e.g., software) embodying or utilized by any one or more of the techniques or functions described herein. The non-transitory machine readable medium 622 is a tangible medium. A storage device 616 that includes the non-transitory machine readable medium should not be construed as that either the device or the machine-readable medium is itself incapable of having physical movement. The instructions 624 may also reside, completely or at least partially, within the main memory 604, within static memory 606, and/or within the hardware processor 602 during execution thereof by the mobile device 600. While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the mobile device 600 and that cause the mobile device 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 624 may further be transmitted or received over a communications network using a transmission medium 626 via the network interface device 620 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 620 may include one or more physical jacks (e.g., Ethernet, coaxial, or phone jacks) or one or more antennas to connect to the transmission medium 626.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

While only certain features of the system and method have been illustrated and described herein, many modifications and changes will occur to those skilled in the art. It is, therefore, to be understood that the appended claims are intended to cover all such modifications and changes. Method operations may be performed substantially simultaneously or in a different order.

### EXAMPLES

Example 1 is an illumination device comprising: a light-emitting diode (LED) structure containing one or more LED arrays, each LED array divided into segments of substantially identical area that include, at least one LED, the LED structure configured to emit light to illuminate a scene; a light sensor to detect an image of the scene dependent on the light that illuminates the scene; and a processor configured to split the image into regions, provide analytics of the image based on region-based exposure metering of the image using multiple regions, and adjust, based on the analytics, at least one of mechanical or electrical tuning parameters associated with at least one segment of the one or more LED arrays to tune at least one of the light sensor or the processor to account for lighting differences within the scene based on the analytics, at least one of the regions having a different area than at least one other of the regions.

In Example 2, the subject matter of Example 1 includes, wherein the processor is configured to provide the analytics for each frame of multiple frames of the scene.

In Example 3, the subject matter of Examples 1-2 includes, wherein the processor is configured to determine acceptability of the image based on whether image quality metrics of the image are met, the image quality metrics selected from a group of metrics that includes noise level.

In Example 4, the subject matter of Example 3 includes, wherein the group of metrics further include motion artifacts and reduced framerate.

In Example 5, the subject matter of Examples 1-4 includes, wherein the processor is configured to calculate which at least one part of the scene has a highest contribution to noise among multiple contributions to noise, and in response, provide the analytics based on the at least one part of the scene.

In Example 6, the subject matter of Example 5 includes, wherein the contributions to noise include at least one factor from: a length of time that a shutter of the illumination device exposing the light sensor is open, an analog gain level of signals from the light sensor related to the image, and a digital gain level of the processor related to the image.

In Example 7, the subject matter of Examples 1-6 includes, wherein at least one or more of the parameters are selected from a group of parameters that include a shutter speed of a shutter of the illumination device, an analog gain of signals from the light sensor related to the image, and a digital gain of the processor related to the image.

In Example 8, the subject matter of Examples 1-7 includes, wherein the at least one region has an area that is larger than the area of the segments and the at least one other region has the area of the segments.

In Example 9, the subject matter of Example 8 includes, wherein the area of the at least one region has is an integer multiple of the area of the segments.

In Example 10, the subject matter of Examples 8-9 includes, wherein the processor is configured to calculate which portion of the scene has a highest contribution to noise and activate LEDs of the one or more LED arrays that are mapped to the portion based on regions of the region-based exposure metering.

In Example 11, the subject matter of Examples 8-10 includes, wherein the processor is configured to calculate which portion of the scene has a highest contribution to noise and adjust current to drive LEDs of the one or more LED arrays that are mapped to the portion based on particular regions of the region-based exposure metering.

In Example 12, the subject matter of Examples 1-11 includes, wherein the processor is further configured to determine distances of objects in the scene, and provide the analytics based on the distances to distinguish darker or lower reflectance objects in the scene that are relatively close to the illumination device from lighter or higher reflectance objects in the scene that are farther away from the illumination device.

Example 13 is a mobile device comprising: an illumination device comprising: one or more segmented light-emitting diode (LED) arrays, each LED array divided into segments of substantially identical area that include, at least one LED, the LED structure configured to emit light to illuminate a scene; a light sensor configured to detect an image of the scene dependent on the light that illuminates the scene; optics configured to direct the light to the scene and to direct the image to the light sensor; and a shutter configured to, when open, permit the light to impinge on the scene; and a processor configured to split the image into regions, provide analytics of the image based on region-based exposure metering of the image, and adjust, based on the analytics, at least one of mechanical or electrical tuning parameters associated with at least one segment of the one or more LED arrays to tune at least one of the light sensor or the processor to account for lighting differences within the scene based on the analytics, at least one of the regions having a different area than at least one other of the regions.

In Example 14, the subject matter of Example 13 includes, wherein the processor is configured to determine acceptability of the image based on whether image quality metrics of the image are met, the image quality metrics selected from a group of metrics that includes noise level, motion artifacts, and reduced framerate.

In Example 15, the subject matter of Examples 13-14 includes, wherein the processor is configured to calculate which at least one part of the scene has a highest contribution to noise among multiple contributions to noise, and in response, provide the analytics based on the at least one part of the scene.

In Example 16, the subject matter of Examples 13-15 includes, wherein the contributions to noise include at least one factor from: a length of time that a shutter of the illumination device exposing the light sensor is open, an analog gain level of signals from the light sensor related to the image, and a digital gain level of the processor related to the image.

In Example 17, the subject matter of Examples 13-16 includes, wherein: the regions include at least one first region that has an area that is a multiple of an area of the segments and at least one second region that has an area that is identical to the area of the segments, and the processor is configured to provide the analytics for the at least one first region and the at least one second region.

In Example 18, the subject matter of Example 17 includes, wherein the processor is configured to calculate which portion of the scene has a highest contribution to noise and adjust current to drive LEDs of the one or more LED arrays that are mapped to the portion based on particular regions of the region-based exposure metering.

In Example 19, the subject matter of Examples 13-18 includes, wherein the processor is further configured to determine distances of objects in the scene, and provide the analytics based on the distances to distinguish darker or lower reflectance objects in the scene that are relatively close to the illumination device from lighter or higher reflectance objects in the scene that are farther away from the illumination device.

Example 20 is a method of providing an adaptive light source, the method comprising: illuminating a scene using light from one or more light-emitting diode (LED) arrays, each LED array divided into segments of substantially identical area that include, at least one LED; detecting an image of the scene dependent on the light using a light sensor; determining region-based exposure metering of the image using multiple regions, at least one of the regions having a different area than at least one other of the regions; determining exposure modes of the adaptive light source; analyzing the image based on region-based exposure metering of the image and the exposure modes of the adaptive light source; and adjusting, based on the analyzing, at least one of mechanical or electrical tuning parameters associated with at least one segment of the one or more LED arrays to tune at least one of the light sensor or a processor to account for lighting differences within the scene.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least”the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. An illumination device comprising:
a light-emitting diode (LED) structure containing one or more LED arrays, each LED array divided into segments of substantially identical area that include at least one LED, the LED structure configured to emit light to illuminate a scene;
a light sensor to detect an image of the scene dependent on the light that illuminates the scene; and
a processor configured to split the image into regions, provide analytics of the image based on region-based exposure metering of the image using multiple regions, and adjust, based on the analytics, at least one of mechanical or electrical tuning parameters associated with at least one segment of the one or more LED arrays to tune at least one of the light sensor or the processor to account for lighting differences within the scene based on the analytics, at least one of the regions having a different area than at least one other of the regions.

2. The illumination device of claim 1, wherein the processor is configured to provide the analytics for each frame of multiple frames of the scene.

3. The illumination device of claim 1, wherein the processor is configured to determine acceptability of the image based on whether image quality metrics of the image are met, the image quality metrics selected from a group of metrics that includes noise level.

4. The illumination device of claim 3, wherein the group of metrics further include motion artifacts and reduced framerate.

5. The illumination device of claim 1, wherein the processor is configured to calculate which at least one part of the scene has a highest contribution to noise among multiple contributions to noise, and in response, provide the analytics based on the at least one part of the scene.

6. The illumination device of claim 5, wherein the contributions to noise include at least one factor from: a length of time that a shutter of the illumination device exposing the light sensor is open, an analog gain level of signals from the light sensor related to the image, and a digital gain level of the processor related to the image.

7. The illumination device of claim 1, wherein at least one or more of the tuning parameters are selected from a group of tuning parameters that include a shutter speed of a shutter of the illumination device, an analog gain of signals from the light sensor related to the image, and a digital gain of the processor related to the image.

8. The illumination device of claim 1, wherein the at least one of the regions has an area that is larger than the area of the segments and the at least one other of the regions has the area of the segments.

9. The illumination device of claim 8, wherein the area of the at least one of the regions has is an integer multiple of the area of the segments.

10. The illumination device of claim 8, wherein the processor is configured to calculate which portion of the scene has a highest contribution to noise and activate LEDs of the one or more LED arrays that are mapped to the portion based on regions of the region-based exposure metering.

11. The illumination device of claim 8, wherein the processor is configured to calculate which portion of the scene has a highest contribution to noise and adjust current to drive LEDs of the one or more LED arrays that are mapped to the portion based on particular regions of the region-based exposure metering.

12. The illumination device of claim 1, wherein the processor is further configured to determine distances of objects in the scene, and provide the analytics based on the distances to distinguish darker or lower reflectance objects in the scene that are relatively close to the illumination device from lighter or higher reflectance objects in the scene that are farther away from the illumination device.

13. A mobile device comprising:
an illumination device comprising:
one or more segmented light-emitting diode (LED) arrays, each LED array divided into segments of substantially identical area that include at least one LED, the LED structure configured to emit light to illuminate a scene;
a light sensor configured to detect an image of the scene dependent on the light that illuminates the scene;
optics configured to direct the light to the scene and to direct the image to the light sensor; and
a shutter configured to, when open, permit the light to impinge on the scene; and
a processor configured to split the image into regions, provide analytics of the image based on region-based exposure metering of the image, and adjust, based on the analytics, at least one of mechanical or electrical tuning parameters associated with at least one segment of the one or more LED arrays to tune at least one of the light sensor or the processor to account for lighting differences within the scene based on the analytics, at least one of the regions having a different area than at least one other of the regions.

14. The mobile device of claim 13, wherein the processor is configured to determine acceptability of the image based on whether image quality metrics of the image are met, the image quality metrics selected from a group of metrics that includes noise level, motion artifacts, and reduced framerate.

15. The mobile device of claim 13, wherein the processor is configured to calculate which at least one part of the scene has a highest contribution to noise among multiple contributions to noise, and in response, provide the analytics based on the at least one part of the scene.

16. The mobile device of claim 15, wherein the contributions to noise include at least one factor from: a length of time that a shutter of the illumination device exposing the light sensor is open, an analog gain level of signals from the light sensor related to the image, and a digital gain level of the processor related to the image.

17. The mobile device of claim 13, wherein:
the regions include at least one first region that has an area that is a multiple of an area of the segments and at least one second region that has an area that is identical to the area of the segments, and
the processor is configured to provide the analytics for the at least one first region and the at least one second region.

18. The mobile device of claim 17, wherein the processor is configured to calculate which portion of the scene has a highest contribution to noise and adjust current to drive LEDs of the one or more LED arrays that are mapped to the portion based on particular regions of the region-based exposure metering.

19. The mobile device of claim 13, wherein the processor is further configured to determine distances of objects in the scene, and provide the analytics based on the distances to distinguish darker or lower reflectance objects in the scene that are relatively close to the illumination device from lighter or higher reflectance objects in the scene that are farther away from the illumination device.

20. A method of providing an adaptive light source, the method comprising:
illuminating a scene using light from one or more light-emitting diode (LED) arrays, each LED array divided into segments of substantially identical area that include at least one LED;
detecting an image of the scene dependent on the light using a light sensor;
determining region-based exposure metering of the image using multiple regions, at least one of the regions having a different area than at least one other of the regions;
determining exposure modes of the adaptive light source;
analyzing the image based on region-based exposure metering of the image and the exposure modes of the adaptive light source; and
adjusting, based on the analyzing, at least one of mechanical or electrical tuning parameters associated with at least one segment of the one or more LED arrays to tune at least one of the light sensor or a processor to account for lighting differences within the scene.
